(19) United States
(12) Patent Application Publication
(10) Pub. No.: US 2024/0399367 A1
(43) Pub. Date: Dec. 5, 2024

(54) CURVILINEAR FLUIDIC DEVICE

(71) Applicant: The Regents of the University of California, Oakland, CA (US)

(72) Inventors: Tien-Chieh HUNG, Davis, CA (US); Stephany Aguayo URIBE, Tracy, CA (US); Steven NGUYEN, Davis, CA (US)

(21) Appl. No.: 18/680,555

(22) Filed: May 31, 2024

Related U.S. Application Data
(60) Provisional application No. 63/505,500, filed on Jun. 1, 2023.

(51) Int. Cl. B01L 3/00

(52) U.S. Cl. CPC B01L 3/502753; B01L 2300/0848; B01L 2300/0864

(57) ABSTRACT

According to one embodiment of the present disclosure, devices, systems, and methods for separating irregular particles by size. A fluidic device for zooplankton separation includes at least one inlet and a curvilinear channel having multiple sub-outlet divisions arranged along a fluidic path of the fluidic device. The multiple sub-outlet divisions include at least two first sub-outlets and at least four second sub-outlets. The least two second sub-outlets extend from each of the at least two first sub-outlets. A method of separating zooplankton includes introducing a mixture including irregular particles into at least one inlet of a micro-fluidic device. The method further includes guiding the mixture including the irregular particles through a curvilinear microchannel of the device. The method includes separating larger and smaller particles based on inertial forces between two first sub-outlets and separating larger and smaller particles from a pre-separated fluid between two second sub-outlets.

### CROSS-REFERENCE TO RELATED APPLICATION

The present application claims the benefit of and the priority to U.S. Provisional Application No. 63/505,500, filed on Jun. 1, 2023, which is hereby incorporated by reference in its entirety for all purposes.

### BACKGROUND OF THE INVENTION

Many scientific studies of micro-entities include at least some level of filtration, sorting, or separation. For example, zooplankton are an important element of the aquatic food chain and studying zooplankton includes separating and identifying different species of zooplankton. Differentiating and imaging similar species may be difficult due to the size of various zooplankton species.

### BRIEF SUMMARY OF THE INVENTION

According to one embodiment of the present disclosure, a fluidic device for micro-entity separation includes at least one inlet and a curvilinear channel having multiple sub-outlet divisions arranged along a fluidic path of the fluidic device. The fluidic device may be used for filtering, sorting, and separating micro-entities such as microplastics, cells, bacteria, viruses, and fungi, microorganisms, etc. In an exemplary embodiment, a fluidic device for zooplankton separation includes at least one inlet and a curvilinear channel having multiple sub-outlet divisions arranged along a fluidic path of the fluidic device. The multiple sub-outlet divisions include at least two first sub-outlets and at least four second sub-outlets. The least two second sub-outlets extend from each of the at least two first sub-outlets.

The curvilinear channel may include a cross section defined by a constant diameter and circumference along the channel. The curvilinear channel may be a spiral channel. The spiral channel may include at least 6 spirals prior to the at least two first sub-outlets. The curvilinear channel may include at least four outlets. Each one of the at least four outlets may extend from a respective one of the at least four second sub-outlets. In various embodiments, a first outlet collects first objects in a first size range, a second outlet collects second objects in a second size range, where the first objects are different from the second objects, a third outlet collects third objects in a third size range, etc.

In an exemplary embodiment, a first outlet collects first particles in a range of about 100 μm to 300 μm. A second outlet collects first zooplankton in a range of about 350 μm to 500 μm. A third outlet collects first zooplankton in a range less than or equal to 350 μm. A fourth outlet collects third zooplankton in a range of less than or equal to 150 μm.

According to another embodiment of the present disclosure, a method of separating objects, such as zooplankton, includes introducing a mixture including irregular particles into at least one inlet of a micro-fluidic device. The method further includes guiding the mixture including the irregular particles through a curvilinear microchannel of the device. The method includes separating larger and smaller particles based on inertial forces between two first sub-outlets and separating larger and smaller particles from a pre-separated fluid between two second sub-outlets.

The method may include optional embodiments. The microchannel may include a cross section defined by a constant diameter and circumference along the microchannel. The mixture may be introduced into the at least one inlet by manual insertion using a syringe. The mixture may be introduced into the at least one inlet at a constant rate. The curvilinear microchannel may be a spiral microchannel. The spiral microchannel may include at least 6 spirals prior to the two first sub-outlets. The spiral microchannel may include at least four outlets. Each one of the at least four outlets may extend from a respective one of the at least four second sub-outlets. Each of the at least four outlets may collect at least a portion of the mixture.

The method may include collecting particles in a range of about 100 μm to 300 μm in a first container coupled to a first outlet of the at least four outlets. The method may include collecting first zooplankton in a range of about 350 μm to 500 μm in a second container coupled to a second outlet of the at least four outlets. The method may include collecting second zooplankton in a range less than or equal to 350 μm in a third container coupled to a third outlet of the at least four outlets. The method may include collecting third zooplankton in a range of less than or equal to 150 μm in a fourth container coupled to a fourth outlet of the at least four outlets. The method may include imaging the mixture collected at each of the at least four outlets.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a curvilinear fluidic device according to various embodiments of the present disclosure.

FIG. 2 illustrates various separation results using an embodiment of a curvilinear fluidic device according to various embodiments of the present disclosure.

FIG. 3 illustrates the results of an experiment using an embodiment of a curvilinear microchannel system according to various embodiments of the present disclosure.

### DETAILED DESCRIPTION OF THE INVENTION

According to at least some embodiments of the present disclosure, a curvilinear fluidic device is disclosed. The curvilinear fluidic device may be used and is described as for separation of zooplankton species, according to various embodiments, however, it should not be interpreted as limited to this specific application. For example, the curvilinear fluidic device as described herein may be used for the separation of microplastics, nutrients, suspended solids such as drugs, cells, gels, emulsions, nano- or micro-sized particles, etc., or any combination thereof. Various embodiments of the present disclosure may be particularly useful for separating fragile particles in liquids, which common filtering methods may damage or break. Other applications include separating zooplankton and phytoplankton in water or removing soft and flexible macroparticles. Any particles having irregular shapes may be filtered and separated using any of the embodiments described herein. For example, embodiments of the present disclosure may be scaled for larger applications by incorporating longer channels and/or increasing the diameters of the channels, based at least in part on the intended application. Various chemical engineering and research projects would benefit from a scalable device as described herein.

Zooplankton are an important element of the aquatic food chain and, as such, it is desirable to document and differentiate zooplankton as a way to observe the health of the ecosystem the zooplankton inhabit. Current methods to identify zooplankton, such as a Planktoscope, available from Planktoscope at https://www.planktoscope.org/and 14 All. St Frangois 29600 St Martin des Champs-France, are viable options but are inefficient. One way to improve the efficiency of imaging zooplankton is to separate zooplankton by size. Methods of zooplankton separation include sieving filtration and floatation. These techniques are inefficient and inaccurate.

Floatation techniques are based on the specific gravity of a liquid including debris, organisms of interest, other particles of interest, etc. Floatation techniques use chemicals, such as tetrachloride and magnesium sulfide, that are used to float organisms but are harmful for zooplankton or other organisms. Sucrose based solutions can replace these chemicals in some instances. However, sucrose floatation results in less accurate separation. For example, sucrose floatation does not account for differences in settling velocity. Sieving is another method of separation which is generally inefficient. For example, some species of zooplankton have spikes or other protrusions that may get caught on the sieves causing the sieves to break (e.g., losing all effectiveness). Accordingly, there is a need in the art for an improved method of separation of micro-entities such as zooplankton.

Various embodiments of the present disclosure use inertial forces to separate zooplankton samples with multiple sizes at the micron scale into different size groups. In some embodiments, the curvilinear fluidic device may be used to treat a continuous water flow containing small, fragile particles (such as zooplankton) that may have spikes or other projections which would otherwise plug or tear a sieve. In various embodiments, the curvilinear fluidic device may be used to treat batched field survey samples.

Although “microchannel” and “micro-fluidic” are used to describe various embodiments of the present disclosure, it should be appreciated by one having ordinary skill in the art that the curvilinear fluidic device described throughout the present disclosure may be separate irregular particles of any size, shape, or configuration.

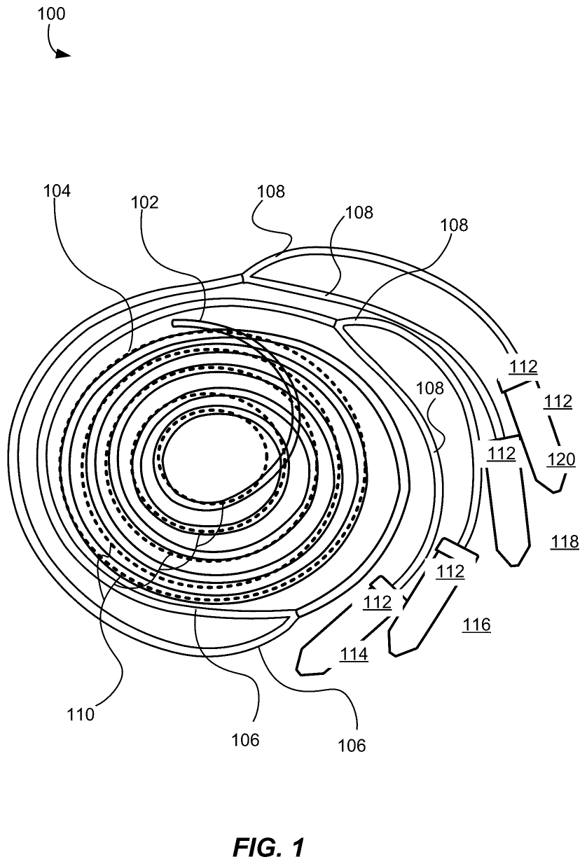

FIG. 1 illustrates an embodiment of a curvilinear fluidic device. The curvilinear fluidic device 100 includes at least one inlet 102 and a microchannel 104 having a cross section defined by a constant diameter and circumference along the microchannel 104. In various embodiments, the cross section of the spiral microchannel is a circle. The curvilinear fluidic device 100 includes at least two first sub-outlets 106 extending from the inlet 102 and from the microchannel 104. The curvilinear fluidic device 100 further includes at least four second sub-outlets 108. At least two second sub-outlets 108 extend from each of the at least two first sub-outlets 106. In various embodiments, any number of pairs of first sub-outlets 106 may be implemented where each first sub-outlet 106 further includes at least two second sub-outlets 108 extending therefrom.

According to at least some embodiments, the construction of the curvilinear fluidic device 100 may be flexible and variable based at least in part on the intended application and/or based on the tubing options available on the market. The diameter of microchannel 104 may be between 1 mm to 50 mm, inclusive. In some embodiments, the curvilinear fluidic device 100 may include a variety different sizes of tubes for different outlets. Additionally, the length of each microchannel 104 may vary to achieve different performance outcomes.

In at least some embodiments, the microchannel 104 having a cross section defined by a constant diameter and circumference along the microchannel 104 is a spiral microchannel. The microchannel 104 may be a spiral microchannel having at least 6 spirals 110 prior to the at least two first sub-outlets 106. For example, the microchannel 104 includes at least 6 spirals 110 between the inlet 102 and the at least two first sub-outlets 106. In other embodiments, at least 5 spirals 110, at least 4 spirals 110, at least 3 spirals 110, etc., may be used. A number of spirals 110 may be determined based at least in part on the intended application and/or the sizes of particles to be filtered. As a liquid mixture travels through the first 3 spirals 110, the shear-gradient inertial lift forces and the wall-induced inertial lift forces act on the particles in the liquid mixture and pull the particles upward. Further down the microchannel 104 (e.g., through any additional spirals 110, closer to the outlets 112) the drag force and the inertial lift force pull the particles to inner walls of the microchannel 104 (toward the inside or outside directions) according to the size of the particles. As the particles travel and by the time the particles reach the outlets 112, the particles are separated by size (larger particles moving toward the outermost sub-outlet and smaller particles moving into the innermost sub-outlet at a respective division into two sub-outlets). In at least some embodiments, at least a portion of the curvilinear fluidic device 100, such as the microchannel 104, includes soft tubing that is shaped into the at least 6 spirals 110. In one exemplary embodiment, the microchannel 104 includes polyvinyl chloride (PVC) vinyl-flex tubing. In other embodiments, the microchannel 104 may include PVC, polyethylene (PE), silicone, polytetrafluoroethylene (PTFE), polypropylene (PP), nylon, rubber (natural and synthetic), etc., or any combination thereof. It is appreciated that more or fewer spirals could be used before the sub-outlets. As can be seen, the sub-outlet tubing portions are arranged so that the first sub-outlet pair provide a first level of division between larger/smaller particles, and each of the second sub-outlet pairs provides a second level of divisional between larger/smaller particles previously divided by the first sub-outlet pair.

In various embodiments, the curvilinear fluidic device 100 includes at least four outlets 112. Each outlet 112 extends from a respective one of the at least four second sub-outlets 108. In various embodiments, each outlet 112 may have sample tubes or other containers extending therefrom to collect the separated particles. A first container 114 is configured to collect first particles in the range of about 100 μm to 300 μm. A second outlet container 116 is configured to collect first zooplankton in the range of about 350 μm to 500 μm. A third container 118 is configured to collect second zooplankton in the range less than or equal to 350 μm. A fourth container 120 is configured to collect third zooplankton in the range of less than or equal to 150 μm. In various embodiments, particles in a range of 100 μm to 200 μm, more specifically about 150 μm, include rotifer zooplankton. Furthermore, particles in a range of about 350 μm to 500 μm include artemia zooplankton. Particles between about 10 μm to 150 μm include algae. The range of sizes that any of the outlets 112 is configured to receive may be varied depending on the length of the microchannel 104, the number of spirals 110, the number of first sub-outlets 106, the number of second sub-outlets 108, the cross section of the microchannel 104, etc., or any combination thereof.

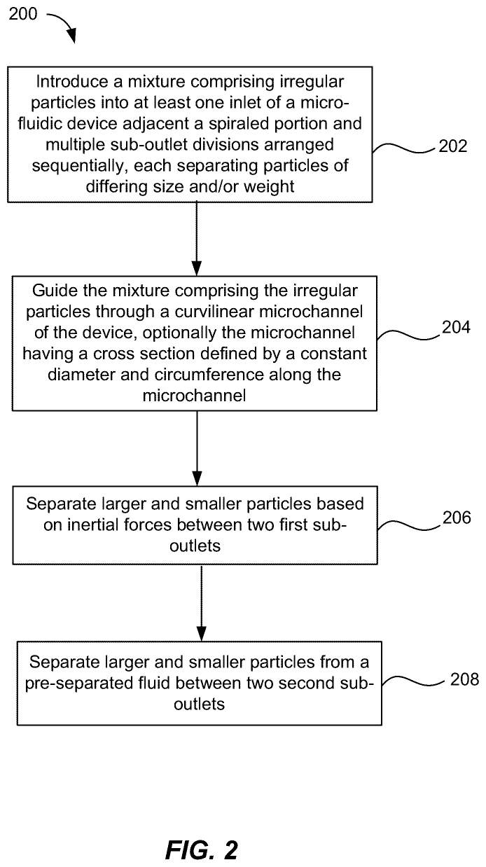

Referring now to FIG. 2, a method 200 of separating zooplankton is described. Method 200 includes step 202. Step 202 includes introducing a mixture including irregular particles into at least one inlet of a micro-fluidic device having multiple sub-outlet divisions arranged sequentially along the fluidic path. Step 202 may include introducing the mixture in a batch style, such as via injection, or in a continuous flow style, such as via a pump or the like. Typically, the fluidic device includes an inlet adjacent a first portion having multiple spirals (e.g., 4 or more, 6 or more) and a second portion having multiple sub-outlet divisions arranged sequentially so that each division separates larger and smaller particles, each subsequent sub-outlet division separating larger and smaller particles from pre-separated fluid, thereby providing separations between multiple sizes of particles (e.g., 4 or more, 6 or more, etc.). In some embodiments, the channels of the fluidic device extend along a common plane. This aids in ensuring the sub-outlet divisions are disposed so that inertial forces separate the smaller and larger particles, one sub-outlet being disposed toward an inside direction and the other being disposed toward the outer direction of the spirals of the device. In various embodiments, the mixture includes water and at least a portion of the irregular particles are a specimen of interest. For example, the mixture may include zooplankton having a plurality of species. Different specifies may be different sizes. In other embodiments, the mixture may include any specimen of interest including microplastics, nutrients, suspended solids such as drugs, cells, gels, emulsions, nano- or micro-sized particles, etc., or any combination thereof. The mixture may include water including seawater, freshwater, brackish water, etc., bodily fluids such as blood, saliva, etc., or any combination of fluids. In various embodiments, the irregular particles are separated from unwanted particles that may include dirt or debris including plant material, dead organisms, etc., other organisms not of interest, etc., or any combination thereof.

Step 204 includes guiding the mixture including the irregular particles through a curvilinear microchannel of the device. In some embodiments, the microchannel includes a cross section defined by a constant diameter and circumference along the microchannel. For example, the microchannel is a spiral channel having a circular shape such that the diameter and circumference is substantially consistent along the length of the spiral microchannel. This is advantageous as it allows for use of standard, off-the-shelf tubing, which considerably reduces cost of manufacture. In some embodiments, the diameter of the microchannel is ⅛ inch. In various embodiments, the diameter may be between 1 mm and 50 mm, inclusive. It is appreciated that in other embodiments, the tubing could be any shape such as an oval, rectangle, square, triangle, trapezoid, etc. According to various embodiments, different shapes and/or diameters may be used in any combination throughout the device. In various embodiments, the microchannel includes an inlet and the mixture may be injected into the inlet or otherwise directed through the inlet. For example, a user may use a syringe to manually insert the mixture at a substantially constant rate into the inlet. In other embodiments, the inlet is connected to a steady stream of the mixture in manner which would be appreciated by one having ordinary skill in the art in view of the present disclosure.

Step 206 includes separating larger and smaller particles based on inertial forces between two first sub-outlets. The mixture flows through the at least six inner loops (e.g., the at least six spirals) to the first two outlets (e.g., a y-shaped connector having two outlets such as the first sub-outlets 106 shown in FIG. 1). Step 208 includes separating larger and smaller particles from a pre-separated fluid between two second sub-outlets. The mixture continues to flow through each of the first two outlets that are further divided into four additional outlets (e.g., such as the at least four second sub-outlets 108 shown in FIG. 1). Two y-shaped connectors may be used to divide the first two outlets into the four additional outlets. Inertial lift forces and drag forces filter the mixture and/or the irregular particles by size as the mixture including the irregular particles is flowed through the curvilinear microchannel system. Shear stress caused by the material and the size of the tubing may also contribute to the filtration process.

In at least some embodiments, method 200 optionally includes collecting particles in a range of about 100 μm to 300 μm in a first container coupled to a first outlet of the at least four outlets. The method may also include collecting first zooplankton in a range of about 350 μm to 500 μm in a second container coupled to a second outlet of the at least four outlets. The method may further include collecting second zooplankton in a range less than or equal to 350 μm in a third container coupled to a third outlet of the at least four outlets. The method may also include collecting third zooplankton in a range of less than or equal to 150 μm in a fourth container coupled to a fourth outlet of the at least four outlets.

In various embodiments, any container that can receive flow from each of the outlets may be used. In other embodiments, no containers are used, and the outlets may be open-ended. In an exemplary embodiment, centrifuge flasks with drilled holes on the caps are used to collect the separated irregular particles at the distal end of each of the four additional outlets. The holes in the caps may decrease the pressure in the system to prevent the irregular particles from flowing in the reverse direction when the syringe or other input is removed from the inlet. The four additional outlets (e.g., referred to with reference to FIG. 1 as the outlets) collect the irregular particles based on size. For example, each outlet may be configured to receive irregular particles in a size range that is different than a size range of irregular particles that another of the outlets is configured to receive. In various embodiments, the size range that each outlet is configured to receive may overlap with one or more other outlet. In at least some embodiments, at least some components may be pinned down to a foam board. For example, the curvilinear microchannel and the outlets may be pinned down to the foam board to stabilize the system during operation (e.g., during flow and separation of the mixture). This ensures the spatial arrangement of the sub-outlet divisions relative the inertial forces on the particles generated in the spirals, as discussed above.

In some embodiments, the curvilinear microchannel system as described in FIGS. 1-2 is advantageously durable, lightweight, and easy to transport. Tubing used for the curvilinear microchannel may be transparent or semi-transparent to enable a user to observe the separation process. The system is further able to receive a cleaning solution that is run through the system for efficiently cleaning the system between uses. The cleaning solution may include hot water, steam, ethanol, water with different pH, other solvents, etc., or any combination thereof.

In a particular application, the curvilinear microchannel system as described in FIGS. 1-2 is used to differentiate and captures images of zooplankton or similar species. The zooplankton may be separated by size, thereby enabling more efficient identification through imaging. A Planktoscope may be used to analyze the samples collected from the curvilinear microchannel system. The Planktoscope uses a Raspberry pi and integrated software to capture images of zooplankton. The curvilinear microchannel system as described herein provides improved clarity of the images and more efficient identification of species of zooplankton as compared to images produced by samples collected from alternative filtration and separation mechanisms such as sieving.

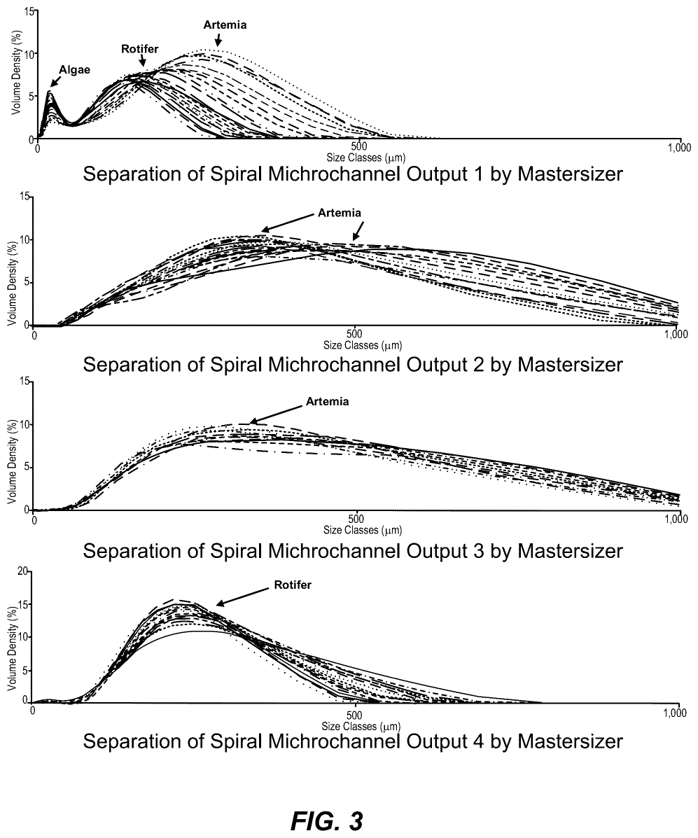

FIG. 3 illustrates the results of an experiment using an embodiment of the curvilinear microchannel system described herein. According to the experiment, 20 mL of artemia zooplankton species and 20 mL of rotifer zooplankton species were measured and mixed in water. Artemia species are characterized by a size range between 100 μm and 200 μm. Rotifer species are characterized by a size range between 300 μm and 600 μm. The mixture including the artemia and the rotifer zooplankton is inserted through the inlet of the curvilinear microchannel and is flowed through the spirals toward the four outlets, such as those described and shown in FIGS. 1-2. A Mastersizer 3000, Malvern Panalytical Ltd, Enigma Business Park, Grovewood Road, Malvern, WR14 1XZ United Kingdom, a particle analyzer, was used to analyze each of the outputs to validate separation of the zooplankton species and their respective size groups. While particular zooplankton species and sizes are described here, it is appreciated that the device could be designed for various other zooplankton species and associated sizes as well.

Species were determined based on size such that outputs having a size less than 100 μm were algae, outputs having a size between 100 μm and 300 μm were rotifers, and outputs having a size greater than 300 μm were artemia. Based on the peaks indicated in each of the outputs, the curvilinear microchannel effectively separate the two zooplankton species from each other. Furthermore, the images obtained from the Planktoscope using the outputs were significantly improved compared to other separation methods.

In other embodiments, the curvilinear microchannel system as described herein may be used to separate algae by concentration. In further embodiments, the curvilinear microchannel system as described herein may be used to separate microplastics greater than 1000 μm from water samples acquired from aquaculture ponds or entire ponds. In yet further embodiments, the curvilinear microchannel system as described herein may be used to separate phosphorous, nitrogen, and suspended solids. In yet further embodiments, the curvilinear microchannel system as described herein may be used to separate cells, drugs, emulsions, and nanometer-sized particles.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A fluidic device for particle separation comprising:
at least one inlet;
a curvilinear channel having multiple sub-outlet divisions arranged along a fluidic path of the fluidic device, wherein the multiple sub-outlet divisions comprise:
at least two first sub-outlets; and
at least four second sub-outlets, wherein at least two second sub-outlets extend from each of the at least two first sub-outlets.

2. The device of claim 1, wherein the curvilinear channel comprises a cross section defined by a constant diameter and circumference along the channel.

3. The device of claim 1, wherein the curvilinear channel is a spiral channel.

4. The device of claim 3, wherein the spiral channel comprises at least 6 spirals prior to the at least two first sub-outlets.

5. The device of claim 1, wherein the curvilinear channel comprises at least four outlets, each one of the at least four outlets extending from a respective one of the at least four second sub-outlets.

6. The device of claim 5, wherein a first outlet is configured to collect first particles in a range of about 100 μm to 300 μm.

7. The device of claim 5, wherein a second outlet is configured to collect first zooplankton in a range of about 350 μm to 500 μm.

8. The device of claim 5, wherein a third outlet is configured to collect first zooplankton in a range less than or equal to 350 μm.

9. The device of claim 5, wherein a fourth outlet is configured to collect third zooplankton in a range of less than or equal to 150 μm.

10. A method of separating irregular particles in a mixture, comprising:
introducing the mixture comprising the irregular particles into at least one inlet of a micro-fluidic device;
guiding the mixture comprising the irregular particles through a curvilinear microchannel of the device;
separating larger and smaller particles based on inertial forces between two first sub-outlets; and
separating larger and smaller particles from a pre-separated fluid between two second sub-outlets.

11. The method of claim 10, wherein the mixture is introduced into the at least one inlet by manual insertion using a syringe.

12. The method of claim 10, wherein the mixture is introduced into the at least one inlet at a constant rate.

13. The method of claim 10, wherein the curvilinear microchannel is a spiral microchannel.

14. The method of claim 13, wherein the spiral microchannel comprises at least 6 spirals prior to the two first sub-outlets.

15. The method of claim 13, wherein the spiral microchannel comprises at least four outlets, each one of the at least four outlets extending from a respective one of the at least four second sub-outlets.

16. The method of claim 15, wherein each of the at least four outlets is configured to collect at least a portion of the mixture.

17. The method of claim 15, further comprising collecting particles in a range of about 100 μm to 300 μm in a first container coupled to a first outlet of the at least four outlets.

18. The method of claim 15, further comprising collecting first zooplankton in a range of about 350 μm to 500 μm in a second container coupled to a second outlet of the at least four outlets.

19. The method of claim 15, further comprising collecting second zooplankton in a range less than or equal to 350 μm in a third container coupled to a third outlet of the at least four outlets.

20. The method of claim 15, further comprising collecting third zooplankton in a range of less than or equal to 150 μm in a fourth container coupled to a fourth outlet of the at least four outlets.
